(19) United States
(12) Patent Application Publication
(10) Pub. No.: US 2022/0228042 A1
(43) Pub. Date: Jul. 21, 2022

(54) ADHESIVE COMPOSITION, ADHESIVE FILM, AND FOLDABLE DISPLAY DEVICE COMPRISING SAME

(71) Applicant: LG CHEM, LTD., Seoul (KR)

(72) Inventors: Hee SONG, Daejeon (KR); Hyon Gyu PARK, Daejeon (KR); Hyun Cheol KIM, Daejeon (KR); Seung Yeon RYU, Daejeon (KR)

(73) Assignee: LG CHEM, LTD., Seoul (KR)

(21) Appl. No.: 17/612,865

(22) PCT Filed: Sep. 28, 2020
(86) PCT No.: PCT/KR2020/013231

§ 371 Date: Nov. 19, 2021

(30) Foreign Application Priority Data
Sep. 26, 2019 (KR) 10-2019-0118908

(51) Int. Cl. C09J 133/08; C09J 11/06; C09J 7/25; C09J 7/38

(52) U.S. Cl. CPC C09J 133/08; C09J 11/06; C08K 5/11; C09J 7/385; C09J 2301/312; C09J 7/255

(57) ABSTRACT

The present invention relates to an adhesive composition including an acrylic polymer having a glass transition temperature of −40° C. or less and a citric acid ester-based compound whose ends are substituted with hydrogen or an alkyl group, an adhesive film, and a foldable display device.

This application is a 35 U.S.C. 371 National Phase Entry Application from PCT/KR2020/013231, filed on Sep. 28, 2020 and designating the United States, which claims priority to and the benefit of Korean Patent Application No. 10-2019-0118908 filed in the Korean Intellectual Property Office on Sep. 26, 2019, the entire contents of which are incorporated herein by reference.

### TECHNICAL FIELD

The present invention relates to an adhesive composition, an adhesive film, and a foldable display device including the same.

### BACKGROUND OF THE INVENTION

Recently, mobile terminals such as mobile communication terminals (wireless terminals), personal digital assistants (PDAs), portable multimedia players (PMPs), and electronic organizers tend to be smaller in size for the purpose of portability.

However, since a user wants to receive information from various contents such as text information, videos, and games through a screen of a mobile terminal, he or she is demanding that the size of the display screen be increased or widened. However, since the miniaturization of mobile terminals brings about a reduction in the size of the display screen, there is a limitation in satisfying both requirements.

As a display device in the related art, a display which is not deformed (unbreakable display) has been used, but in order to overcome the aforementioned limitations, a display having a curved surface (curved display), a bent display, a foldable display, a rollable display, and the like have been developed.

Currently, the commercialization stage is merely in the mobile field in the form of a bent display, and it is expected that the mobile field utilizing a foldable display will appear in earnest. Further, the development speed in the (automobile) electricity field using pOLEDs is also remarkable.

In general, adhesive films used in foldable displays are designed with low modulus to relieve interlayer stresses.

In this case, in order to have excellent folding characteristics in a wide temperature range from low temperature to high temperature, it is advantageous to keep the modulus at low temperature as low as possible while maintaining the modulus at high temperature.

In order to lower the modulus at low temperature, it is common to use a monomer with a low glass transition temperature (Tg) as a base material, but it is difficult to lower the modulus to 3×10⁶ Pa or less at low temperature (for example, −40° C.), and there is a problem in that the modulus at high temperature is also lowered.

Since there are problems in that the folding characteristics deteriorate when the modulus at low temperature is high and a residue phenomenon occurs or bleed-out occurs when the high-temperature modulus is low, it is important to have a uniform modulus within a wide temperature interval.

### BRIEF SUMMARY OF THE INVENTION

The present invention has been made in an effort to provide an adhesive composition providing excellent folding recovery characteristics while maintaining a storage elastic modulus in a wide temperature range, an adhesive film, and a foldable display device including the same.

An exemplary embodiment of the present invention provides an adhesive composition including: an acrylic polymer having a glass transition temperature of −40° C. or less; and a citric acid ester-based compound whose ends are substituted with hydrogen or an alkyl group.

Further, an exemplary embodiment of the present invention provides an adhesive film including a dried or cured product of the above-described adhesive composition and satisfying the following Equations 1 and 2.

1×10⁴≤G1′≤1×10⁶ [Equation 1]

1×10⁴≤G2′≤1×10⁵ [Equation 2]

in Equations 1 and 2,

G1′ is a storage elastic modulus (Pa) at −20° C., and

G2′ is a storage elastic modulus (Pa) at 90° C.

In addition, an exemplary embodiment of the present invention provides a foldable display device including the above-described adhesive film.

### Advantageous Effects

The adhesive composition according to an exemplary embodiment of the present invention has an advantage in that the adhesive composition is suitable for use as an adhesive film of a foldable display device because the storage elastic modulus is maintained in a wide temperature interval and the folding characteristics are excellent.

### BRIEF DESCRIPTION OF DRAWINGS

FIGS. 1 to 3 are schematic views of an adhesive film of the present invention.

### DETAILED DESCRIPTION OF THE INVENTION

Hereinafter, the present specification will be described in detail.

When one part “includes” one constituent element in the present specification, unless otherwise specifically described, this does not mean that another constituent element is excluded, but means that another constituent element may be further included.

An exemplary embodiment of the present invention provides an adhesive composition including: an acrylic polymer having a glass transition temperature of −40° C. or less; and a citric acid ester-based compound whose ends are substituted with hydrogen or an alkyl group.

The present invention provides an adhesive composition in which the storage elastic modulus is maintained in a wide temperature interval and folding recovery characteristics are excellent. Specifically, the adhesive composition stretches easily and recovers well at low temperature by keeping the low-temperature modulus low, and thus needs to have an effect of improving the folding recovery characteristics (low-temperature characteristics). Furthermore, the modulus is kept high at high temperature to prevent the adhesive composition from overstretching at high temperature, thereby preventing a bleed-out problem.

In this case, the flexibility of the acrylic polymer needs to be increased in order to keep the low-temperature modulus low, and the flexible structure of the acrylic polymer may further improve folding recovery characteristics at low temperature by increasing the free volume of the resin and lowering the glass transition temperature (Tg) of the entire adhesive film.

The free volume means an empty space in which the polymer chain can move freely, the glass transition temperature is a temperature when the polymer chain has a universal free volume, and at the temperature or less, the movement of the polymer chain will decrease or stop.

In the present invention, in order to increase the flexibility of the acrylic polymer, the citric acid ester-based compound whose ends were substituted with hydrogen or an alkyl group was included in the adhesive composition. The citric acid ester-based compound was suppressed from readily reacting with an acrylic polymer because the structure of the citric acid ester-based compound is not complicated (steric) and the ends of the compound is not substituted with a highly reactive reaction group such as —SH. Through this, the citric acid ester-based compound easily flows into the structural unit of the acrylic polymer and the free volume of the acrylic polymer is increased, thereby increasing the flexibility of the polymer.

The weight average molecular weight of the citric ester-based compound whose ends are substituted with hydrogen or an alkyl group may be adjusted within a range in which the function of the above-described citric acid ester-based compound is maintained, and may be specifically 1,000 g/mol or less (more than 0), more than 0 and 1,000 g/mol or less, preferably more than 0 and 700 g/mol or less, and more preferably more than 0 and 500 g/mol or less. When the above range is satisfied, the structure of the citric acid ester-based compound is not too complicated (steric), so that the flexibility of the polymer may be maintained.

The weight average molecular weight (Mw) may be measured as follows. First, an analyte is put into a 5 mL vial, and is diluted in tetrahydrofuran (THF) to have a concentration of about 1 mg/mL. Thereafter, after a standard sample for calibration and a sample to be analyzed are filtered by a syringe filter (pore size=0.45 unn), and the GPC is measured. As an analysis program, ChemStation from Agilent technologies may be used, and the weight average molecular weight (Mw) may be each obtained by comparing the elution time of the sample with the calibration curve. The measurement conditions of the GPC may be as follows.

Instrument: 1200 series from Agilent technologies

Column: uses two PL gel mixed B's from Polymer laboratories

Solvent: THF

Column temperature: 40° C.

Sample concentration: 1 mg/mL, injection of 100 L

Standard sample: Polystyrene (Mp: 3900000, 723000, 316500, 52200, 31400, 7200, 3940, and 485)

An alkyl group of the citric acid ester-based compound whose ends are substituted with hydrogen or an alkyl group may be adjusted within a range in which the structure of the citric acid ester-based compound is not complicated, and may be specifically a straight-chained or branched alkyl group having 1 to 10 carbon atoms, 1 to 6 carbon atoms, or 1 to 4 carbon atoms. Examples of the alkyl group include a methyl group, an ethyl group, a propyl group, an n-propyl group, an isopropyl group, a butyl group, an n-butyl group, an isobutyl group, a tert-butyl group, a sec-butyl group, a 1-methyl-butyl group, a 1-ethylbutyl group, a pentyl group, an n-pentyl group, an isopentyl group, a neopentyl group, a tert-pentyl group, a hexyl group, an n-hexyl group, a 1-methylpentyl group, a 2-methylpentyl group, a 4-methyl-2-pentyl group, a 3,3-dimethylbutyl group, a 2-ethylbutyl group, and the like, but are not limited thereto.

The compound of the citric acid ester-based compound whose ends are substituted with hydrogen or an alkyl group may be adjusted within a range in which the effect of increasing the flexibility of the acrylic polymer is maintained, and specifically, the adhesive composition may include the citric acid ester-based compound whose ends are substituted with hydrogen or an alkyl group in an amount of 5 parts by weight or more and 30 parts by weight or less, 6 parts by weight or more and 25 parts by weight or less, or 8 parts by weight or more and 20 parts by weight or less based on 100 parts by weight of the entire acrylic polymer. There are problems in that when the content is less than the above range, the flexibility effect of the acrylic polymer may deteriorate, and when the content is more than the above range, the adhesive film is easily separated at the time of folding the adhesive film due to the reduction in adhesive strength of the adhesive film.

Examples of a type of citric acid ester-based compound whose ends are substituted with hydrogen or an alkyl group include triethyl citrate, acetyl triethyl citrate, tributyl citrate, acetyl tributyl citrate (ATBC), or acetyl trioctyl citrate.

The glass transition temperature of the acrylic polymer needs to be low in order to lower the modulus of the adhesive film at low temperature. Specifically, the glass transition temperature may be −40° C. or less, −50° C. or less, or −60° C. or less. When the glass transition temperature satisfies the above range, the low-temperature modulus of the adhesive film may be kept low. The glass transition temperature may be calculated by a method generally used in the art to which this technique belongs, and may be calculated by, for example, the following General Formula (1)(Fox formula).

1/Tg=W1/Tg1+W2/Tg2+ . . . +Wn/Tgn [General Formula (1)]

In General Formula (1), Tg, Tgi (i=1, 2, . . . n), and Wi (i=1, 2, . . . n) indicate the glass transition temperature (unit: K) of Polymer A, the glass transition temperature (unit: K) when Monomer i forms a homopolymer, and the mass fraction of Monomer i in the entire monomer component, respectively.

General Formula (1) means a calculation formula when Polymer A includes n types of monomer components of Monomer 1, Monomer 2, . . . , Monomer n.

Meanwhile, the glass transition temperature may be measured by manufacturing a sample having the same composition as that of the acrylic polymer, and then putting about 10 mg of the sample in a dedicated pan, sealing the pan, and plotting the amounts of heat absorbed and generated during a phase transition of a material with respect to temperature while heating the pan at a constant heating rate with a differential scanning calorimetry (DSC, manufactured by METTLER TOLEDO).

The acrylic polymer is composed of a polymerization unit of a (meth)acrylic acid ester monomer and a polymerizable monomer having a cross-linkable functional group.

In the present specification, the term “a polymer is composed of a polymerization unit of a monomer” means a state in which the monomer is polymerized on a skeleton such as a main chain or a side chain of a polymer formed by polymerizing the monomer, and may mean that no polymerization unit of any monomer is included other than the aforementioned monomer. Therefore, the acrylic polymer of the present invention may include no polymerization unit of other monomers other than the (meth) acrylic acid ester monomer and the polymerizable monomer having a cross-linkable functional group. The term “(meth)acrylic acid” means acrylic acid or methacrylic acid.

The type of the (meth)acrylic acid ester monomer is not particularly limited, and may be, for example, an alkyl (meth)acrylate. As described above, the term “(meth)acrylate” means acrylate or methacrylate.

Specifically, the alkyl (meth)acrylate may be an alkyl (meth)acrylate having an alkyl group having 5 to 20 carbon atoms. Examples of the alkyl (meth)acrylate having an alkyl group having 5 to 20 carbon atoms include 2-ethylhexyl (meth)acrylate, 2-ethylbutyl (meth)acrylate, pentyl (meth)acrylate, hexyl (meth)acrylate, cyclohexyl (meth)acrylate, n-octyl (meth)acrylate, isooctyl (meth)acrylate, isononyl (meth)acrylate, decyl (meth)acrylate, dodecyl (meth)acrylate, tridecyl (meth)acrylate, tetradecyl (meth)acrylate, octadecyl (meth)acrylate, isobornyl (meth)acrylate, or the like, but are not limited thereto.

Furthermore, the polymerizable monomer having a cross-linkable functional group included as a polymerization unit in the acrylic polymer may be selected without particular limitation as long as the polymerizable monomer can be polymerized with the (meth)acrylic acid ester monomer which forms the acrylic polymer to provide a cross-linkable functional group in the polymer. The cross-linkable functional group may be selected without limitation as long as the cross-linkable functional group can cause a cross-linking reaction with a cross-linking agent to be described below at a temperature in a range of, for example, about 50 to 300.

The cross-linkable functional group may be any one or more selected from the group consisting of a hydroxyl group, an isocyanate group, a glycidyl group, an epoxy group, an amine group, and a carboxyl group.

Examples of the monomer having a hydroxyl group include a hydroxyalkyl (meth)acrylate such as 2-hydroxyethyl (meth)acrylate, 2-hydroxypropyl (meth)acrylate, 4-hydroxybutyl (meth)acrylate, 6-hydroxyhexyl (meth) acrylate, or 8-hydroxyoxyl (meth) acrylate; a hydroxypolyalkylene glycol (meth)acrylate such as hydroxypolyethylene glycol (meth)acrylate or hydroxypolypropylene glycol (meth)acrylate; and the like, but are not limited thereto.

Examples of the monomer having a carboxyl group include (meth)acrylic acid, 2-(meth)acryloyloxy acetic acid, 3-(meth)acryloyloxy propionic acid, 2-carboxyethyl acrylate, 4-(meth)acryloyloxy butyric acid, an acrylic acid dimer, itaconic acid, maleic acid, maleic anhydride or the like, but are not limited thereto.

Examples of the monomer having an amine group include 2-aminoethyl (meth)acrylate, 3-aminopropyl (meth)acrylate, N,N-dimethylaminoethyl (meth)acrylate, N,N-dimethylaminopropyl (meth)acrylate, or the like, but are not limited thereto.

In the specific example, the cross-linkable functional group may be a carboxyl group.

The acrylic polymer may be composed of a polymerization unit of 90 to 99.5 parts by weight of a (meth)acrylic acid ester monomer and 0.5 to 10 parts by weight of a polymerizable monomer having a cross-linkable functional group.

In other examples, the acrylic polymer may be composed of a polymerization unit of 92 to 99.5 parts by weight of a (meth)acrylic acid ester monomer and 0.5 to 8 parts by weight of a polymerizable monomer having a cross-linkable functional group, or 94 to 99 parts by weight of a (meth)acrylic acid ester monomer and 1 to 6 parts by weight of a polymerizable monomer having a cross-linkable functional group. As described above, the term “part by weight” means the weight ratio between respective components unless otherwise defined.

The weight average molecular weight of the acrylic polymer may be in a range of 5,000 g/mol to 3,000,000 g/mol. The weight average molecular weight may mean a conversion value with respect to standard polystyrene measured by gel permeation chromatograph (GPC), and the molecular weight of any polymer may mean the weight average molecular weight of the polymer unless otherwise specified. In another example, the weight average molecular weight of the acrylic polymer may be in a range of 100,000 g/mol to 2,500,000 g/mol or 500,000 g/mol to 2,200,000 g/mol.

The acrylic polymer may be prepared by various methods. For example, the polymer may be prepared by selecting a necessary monomer among the above-described monomers and applying a mixture of monomers in which the selected monomers are blended in a desired proportion to a method such as a solution polymerization, bulk polymerization, suspension polymerization, or emulsion polymerization method, and may be appropriately prepared by solution polymerization. The method for preparing the polymer by solution polymerization is not particularly limited.

The solution polymerization method may be performed at a polymerization temperature of 50° C. to 140° C. for about 4 to 10 hours by mixing a radical polymerization initiator and a solvent, for example, in a state in which the above-described monomer components are mixed at an appropriate weight ratio.

The radical polymerization initiator used to prepare the acrylic polymer is publicly-known, and it is possible to use, for example, an azo-based polymerization initiator such as azobisisobutyronitrile or azobiscyclohexane carbonitrile; or an oxide-based polymerization initiator such as benzoyl peroxide or acetyl peroxide; and the like.

The polymerization initiators may be used alone or in mixtures of two or more, and the content thereof is preferably about 0.005 to 3 parts by weight based on 100 parts by weight of the entire adhesive composition.

Further, the solvent used to prepare the acrylic polymer is publicly-known, and for example, ethyl acetate, toluene, or the like may be used, but the solvent is not limited thereto.

The adhesive composition may further include a cross-linking agent which cross-links the acrylic polymer.

The cross-linking agent may be a polyfunctional compound including, in one molecule, two or more of any one or more functional groups selected from the group consisting of an alkoxysilane group, a carboxyl group, an acid anhydride group, a vinyl ether group, an amine group, a carbonyl group, an isocyanate group, an epoxy group, an aziridinyl group, a carbodiimide group, and an oxazoline group. The type of functional group may vary depending on the type of cross-linkable functional group included in the acrylic polymer and the mechanism for implementing another cross-linked structure.

Examples of the cross-linking agent including a carboxyl group include aromatic dicarboxylic acids such as o-phthalic acid, isophthalic acid, terephthalic acid, 1,4-dimethylterephthalic acid, 1,3-dimethylisophthalic acid, 5-sulfo-1,3-dimethylisophthalic acid, 4,4-biphenyldicarboxylic acid, 1,4-naphthalene dicarboxylic acid, 2,6-naphthalene dicarboxylic acid, norbornene dicarboxylic acid, diphenylmethane-4,4′-dicarboxylic acid or phenylindane dicarboxylic acid; aromatic dicarboxylic acid anhydrides such as phthalic acid anhydride, 1,8-naphthalenedicarboxylic acid anhydride or 2,3-naphthalenedicarboxylic acid anhydride; alicyclic dicarboxylic acids such as hexahydrophthalic acid; alicyclic dicarboxylic acid anhydrides such as hexahydrophthalic acid anhydride, 3-methyl-hexahydrophthalic acid anhydride, 4-methyl-hexahydrophthalic acid anhydride or 1,2-cyclohexanedicarboxylic acid anhydride; or aliphatic dicarboxylic acids such as oxalic acid, malonic acid, succinic acid, adipic acid, sebacic acid, azelaic acid, suberic acid, maleic acid, chloromaleic acid, fumaric acid, dodecanedioic acid, pimelic acid, citraconic acid, glutaric acid or itaconic acid, and the like.

Examples of the cross-linking agent including an acid anhydride group include pyromellitic acid anhydride, benzophenonetetracarboxylic acid dianhydride, biphenyltetracarboxylic acid dianhydride, oxydiphthalic acid dianhydride, diphenylsulfone tetracarboxylic acid dianhydride, diphenyl sufide tetracarboxylic acid dianhydride, butane tetracarboxylic acid dianhydride, perylene tetracarboxylic acid dianhydride or naphthalene tetracarboxylic acid dianhydride, and the like.

Examples of the cross-linking agent including a vinyl ether group include ethylene glycol divinyl ether, diethylene glycol divinyl ether, triethylene glycol divinyl ether, tetraethylene glycol divinyl ether, pentaerythritol divinyl ether, propylene glycol divinyl ether, dipropylene glycol divinyl ether, tripropylene glycol divinyl ether, neopentyl glycol divinyl ether, 1,4-butanediol divinyl ether, 1,6-hexanediol divinyl ether, glycerin divinyl dether, trimethylol propane divinyl ether, 1,4-dihydroxy cyclohexane divinyl ether, 1,4-dihydroxymethyl cyclohexane divinyl ether, hydroquinone divinyl ether, ethylene oxide-modified hydroquinone divinyl ether, ethylene oxide-modified resorcin divinyl ether, ethylene oxide-modified bisphenol A divinyl ether, ethylene oxide-modified bisphenol S divinyl ether, glycerin trivinyl ether, sorbitol tetravinyl ether, trimethylol propane trivinyl ether, pentaerythritol trivinyl ether, pentaerythritol tetravinyl ether, dipentaerythritol hexavinyl ether, dipentaerythritol polyvinyl ether, ditrimethylolpropane tetravinyl ether or ditrimethylol propane polyvinyl ether, and the like.

Examples of the cross-linking agent including an amine group include aliphatic diamines such as ethylenediamine or hexamethylenediamine; alicyclic diamines such as 4,4′-diamino-3,3′-dimethyldicyclohexylmethane, 4,4′-diamino-3,3′-dimethyldicyclohexyl, diaminocyclohexane or isophoronediamine; aromatic diamines such as xylenediamine, or the like.

Examples of the cross-linking agent including an isocyanate group include an aromatic polyisocyanate such as 1,3-phenylene diisocyanate, 4,4′-diphenyl diisocyanate, 1,4-phenylene diisocyanate, 4,4′-diphenylmethane diisocyanate, 2,4-tolylene diisocyanate, 2,6-tolylene diisocyanate, 4,4′-toluidine diisocyanate, 2,4,6-triisocyanate toluene, 1,3,5-triisocyanate benzene, dianisidine diisocyanate, 4,4′-diphenyl ether diisocyanate, 4,4′,4″-triphenylnnethane triisocyanate, ω,ω-diisocyanate-1,3-dimethyl benzene, ω,ω′-diisocyanate-1,4-dimethyl benzene, ω,′ω-diisocyanate-1,4-diethyl benzene, 1,4-tetramethylacrylylene diisocyanate, 1,3-tetramethylxylene diisocyanate, Xylylene diisocyanate or xylylene diisocyanate; an aliphatic polyisocyanate such as trimethylene diisocyanate, tetramethylene diisocyanate, hexamethylene diisocyanate, pentamethylene diisocyanate 1,2-propylene diisocyanate, 2,3-butylene diisocyanate, 1,3-butalene diisocyanate, dodeca methylene diisocyanate or 2,4,4-tramethylhexamethylenediisocyanate; or an alicyclic polyisocyanate such as 3-isocyanate methyl-3,5,5-trimethylcyclohexylisocyanate, 1,3-cyclopentane diisocyanate, 1,3-cyclohexane diisocyanate, 1,4-cyclohexane diisocyanate, methyl-2,4-cyclohexane diisocyanate, methyl-2,6-cyclohexane diisocyanate, 4,4′-nnethylenebis(cyclohexylisocyanate) or 1,4-bis(isocyanatemethyl)cyclohexane, or the like, or a trimer type of isocyanate, a prepolymer adduct type, a burette type, or a reactant of one or more of the above-described polyisocyanates and a polyol, and the like.

Examples of the cross-linking agent including an epoxy group include ethylene glycol diglycidyl ether, triglycidyl ether, trimethylol propane triglycidyl ether, N,N,N,N′-tetraglycidyl-1,3-xylenediamine, glycerin diglycidyl ether, or the like.

The adhesive composition may include the cross-linking agent in an amount of 0.001 to 5 parts by weight, 0.001 to 3 parts by weight, 0.01 to 2 parts by weight, or 0.02 to 2 parts by weight based on 100 parts by weight of the acrylic polymer.

The adhesive composition may further include, in addition to the acrylic polymer and the citric acid ester-based compound described above, known additional components such as an antistatic agent, an adhesion-imparting resin, a curing agent, an ultraviolet stabilizer, an antioxidant, a toning agent, a reinforcing agent, a filler, a defoamer, a photoinitiator, a thermal initiator, a solvent, or a surfactant, and the like.

The photoinitiator may be substituted with one or two or more substituents selected from the group consisting of a triazine-based compound, a biimidazole-based compound, an acetophenone-based compound, an O-acyloxime-based compound, a thioxantone-based compound, a phosphine oxide-based compound, a coumarin-based compound, and a benzophenone-based compound.

As the photoinitiator, it is possible to use a triazine-based compound such as 2,4-trichloromethyl-(4′-methoxyphenyl)-6-triazine, 2,4-trichloromethyl-(4′-methoxystyryl)-6-triazine, 2,4-trichloromethyl-(pipeulronyl)-6-triazine, 2,4-trichloromethyl-(3′,4′-dimethoxyphenyl)-6-triazine, 3-{4-[2,4-bis(trichloronnethyl)-s-triazine-6-yl]phenylthio}propanoic acid, 2,4-trichloromethyl-(4′-ethylbiphenyl)-6-triazine or 2,4-trichloromethyl-(4′-methylbiphenyl)-6-triazine; a biimidazole compound such as 2,2′-bis(2-chlorophenyl)-4,4′,5,5′-tetraphenyl biimidazole or 2,2′-bis(2,3-dichlorophenyl)-4,4′,5,5′-tetraphenyl biimidazole; an acetophenone-based compound such as 2-hydroxy-2-methyl-1-phenylpropan-1-one, 1-(4-isopropylphenyl)-2-hydroxy-2-methylpropan-1-one, 4-(2-hydroxyethoxy)-phenyl (2-hydroxy)propyl ketone, 1-hydroxycyclohexyl phenyl ketone, 2,2-dimethoxy-2-phenylacetophenone, 2-methyl-(4-nnethylthiophenyI)-2-nnorpholino-1-propan-1-one (Irgacure-907) or 2-benzyl-2-dimethylamino-1-(4-morpholinophenyl)-butan-1-one (Irgacure-369); an O-acyloxinne-based compound such as Irgacure OXE 01 and Irgacure OXE 02 commercially available from Ciba-Geigy Corporation; a benzophenone-based compound such as 4,4′-bis(dimethylamino)benzophenone or 4,4′-bis(diethylamino)benzophenone; a thioxanthone-based compound such as 2,4-diethyl thioxanthone, 2-chlorothioxanthone, isopropylthioxanthone or diisopropylthioxanthone; a phosphine oxide-based compound such as 2,4,6-trimethylbenzoyl diphenylphosphine oxide, bis(2,6-dimethoxybenzoyl)-2,4,4-trimethylpentylphosphine oxide or bis(2,6-dichlorobenzoyl)propylphosphine oxide; a coumarin-based compound such as 3,3′-carbornylvinyl-7-(diethylamino)coumarin, 3-(2-benzothiazolyl)-7-(diethylamino)coumarin, 3-benzoyl-7-(diethylamino)coumarin, 3-benzoyl-7-methoxy-coumarin or 10,10′-carbornylbis[1,1,7,7-tetramethyl-2,3,6,7-tetrahydro-1H,5H,11H-C1]-benzopyrano[6,7,8-ij]-quinolizin-11-one either alone or in mixture of two or more, but the photoinitiator is not limited thereto.

Further, as the thermal initiator, those known in the art may be used.

As the solvent, a generally used organic solvent may be used, a polar aprotic solvent may be used, and specifically, a methyl ethyl ketone, toluene or ethyl acetate solvent may be used.

The present invention provides an adhesive film including a dried or cured product of the above-described adhesive composition and satisfying the following Equations 1 and 2. In this case, Equation 1 may be represented by the following Equation 1-1.

1×10⁴≤G1′≤1×10⁶ [Equation 1]

1×10⁴≤G2′≤1×10⁵ [Equation 2]

in Equations 1 and 2,

G1′ is a storage elastic modulus (Pa) at −20° C., and

G2′ is a storage elastic modulus (Pa) at 90° C.

The adhesive film may satisfy the following Equation 3. The following Equation 3 means a log scale of the difference value (ΔG′) of the storage elastic modulus. In this case, the following Equation 3 may satisfy any one of the following Equations 3-1 to 3-3.

Log(G1′/G2′)≤1 [Equation 3]

0<Log(G1′/G2′)≤1 [Equation 3-1]

0<Log(G1′/G2′)≤0.8 [Equation 3-2]

0<Log(G1′/G2′)≤0.7 [Equation 3-3]

in Equations 3 to 3-3,

G1′ is a storage elastic modulus (Pa) at −20° C., and

G2′ is a storage elastic modulus (Pa) at 90° C.

A publicly-known method may be used for the storage elastic modulus. Specifically, after a sample having the same composition as that of the adhesive film is manufactured to have a thickness of 1 mm, the sample may be measured using a parallel plate fixture having a diameter of 8 mm, and Advanced Rheometric Expansion System G2 (TA Instruments) may be used as equipment to be used. In this case, as the measurement conditions, 1 Hz, 5% strain, and a heating rate of 10° C./min may be selected.

The adhesive film may be a dried or cured product of the above-described adhesive composition. Examples of a drying method include a method of volatilizing a solvent by applying the adhesive composition or adhesive composition to another base material, and then drying the base material in a drying device such as an oven at a temperature of 80° C. or higher for 1 minutes or more.

The haze of the adhesive film at a thickness of 25 unn may be 3% or less, 1% or less, preferably 0.5% or less. In the above range, the adhesive film shows excellent transparency when the adhesive film is applied to a display device. The haze may be measured by a method commonly used in the art to which this technique belongs, and may be measured, for example, by a hazemeter (a COH-400 product manufactured by Nippon Denshoku Industries Co., Ltd.) after laminating an adhesive film to NEG glass 0.5T.

The adhesive film may further include any one or more of a release film and a base film provided on one surface or both surfaces of a dried or cured product of the adhesive composition.

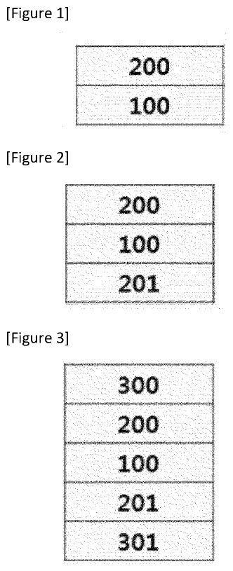

Specifically, the adhesive film 1 may further include a release film 200 provided on one surface of a dried or cured product 100 of the adhesive composition (FIG. 1), and the adhesive film 1 may further include a release film 200 and 201 provided on both surfaces of a dried or cured product 100 of the adhesive composition (FIG. 2).

In addition, the adhesive film 1 may include a release film 200 and 201 and a base film 300 and 301 provided on one surface or both surfaces of a dried or cured product 100 of an adhesive composition. Some of the release film and the base film may be omitted (FIG. 3).

The adhesive film may further include a base film provided on both surfaces of the dried or cured product of the adhesive composition.

The adhesive film may further include a release film provided on both surfaces of the dried or cured product of the adhesive composition.

The base film may be selected from the group consisting of polyethylene terephthalate (PET), polyester, polycarbonate (PC), polyimide (PI), polyethylene naphthalate (PEN), polyether ether ketone (PEEK), polyarylate (PAR), polycylicolefin (PCO), polynorbornene, polyethersulphone (PES), and a cycloolefin polymer (COP).

The base film may have a thickness of 25 μm or more and 300 μm or less, preferably 30 μm or more and 270 μm or less, and more preferably 40 μm or more and 250 μm or less.

It is preferred that the base film is transparent. The meaning that the base film is transparent referred here indicates that the light transmittance of visible light (400 to 700 nm) is 80% or more.

As the release film, a hydrophobic film may be used, the release film is a layer for protecting an adhesive sheet having a very small thickness and refers to a transparent layer which is attached to one surface of an adhesive sheet, and it is possible to use a film which is excellent in mechanical strength, heat stability, moisture shielding property, isotropy, and the like. For example, it is possible to use an acetate-based resin film such as triacetyl cellulose (TAC), a polyester-based resin film, a polyether sulfone-based resin film, a polycarbonate-based resin film, a polyamide-based resin film, a polyimide-based resin film, a polyolefin-based resin film, a cycloolefin-based resin film, a polyurethane-based resin film, an acrylic resin film, and the like, but the release film is not limited thereto as long as the release film is a commercially available silicone-treated release film.

The adhesive film may have a thickness of 5 unn or more and 100 unn or less. The thickness of the adhesive film means the thickness of only the adhesive film except for the base film and the release film provided on one or the other surface of the adhesive film.

The present invention provides a foldable display device including the adhesive film. The foldable display device includes a display unit, an adhesive film, a polarizing plate, a touch screen panel, and a foldable window film, and the adhesive film may include an adhesive film according to the examples of the present invention.

The display unit is for driving a foldable display device, and may include an optical device including a substrate and an OLED, LED, or LCD device formed on the substrate. The display unit may include a substrate, a thin film transistor, an organic light emitting diode, a planarization layer, a protective film, an insulating film, and the like.

Hereinafter, the present invention will be described in more detail through Examples.

<Preparation of Adhesive Film>

1. Preparation of Acrylic Polymer

After a monomer mixture according to the composition shown in the following Table 1 was put into a 1 L reactor equipped with a cooling device such that a nitrogen gas was refluxed and the temperature could be easily controlled, ethyl acetate (EAc) was put thereinto as a solvent. Then, after purging with a nitrogen gas was performed for about 1 hour in order to remove oxygen, the reactor temperature was maintained at 85° C. After the mixture was homogenized, 5,000 ppm of benzoyl peroxide (BPO) as a reaction initiator was put into the reactor, and the mixture was reacted. After the reaction, an acrylic polymer was prepared by diluting the EAc. The glass transition temperature of the acrylic polymer prepared above was measured by a differential scanning calorimetry (DSC) and recorded in the following Table 1.

TABLE 1

| | | | | | Hydroxy | Molecular | Glass transition |
|---|---|---|---|---|---|---|---|
| | Ethylhexyl | Acrylic | Butyl | Lauryl | Butyl | weight | temperature |
| | Acrylate | acid | Acrylate | Acrylate | Acrylate | (10⁴ g/mol) | (° C.) |
| Polymer 1 | 98 | 2 | | | | 200 | −83 |
| Polymer 2 | 60 | | | 20 | 20 | 185 | −58 |
| Polymer 3 | 40 | | | 40 | 20 | 185 | −53 |
| Polymer 4 | | 2 | 50 | 48 | | 200 | −54 |

2. Preparation of Adhesive Composition

A cross-linking agent (BXX-5240) or an isocyanate-based cross-linking agent (BXX-5270 or TKA-100) was mixed with 100 g of the acrylic polymer prepared above, the ester-based compounds in the following Tables 2 and 3 were added thereto, and then the resulting mixture was diluted to a concentration of 18 wt % with an ethyl acetate solution, put thereinto, and then uniformly mixed, thereby preparing an adhesive composition. In this case, the weight of the ester-based compound is a weight based on 100 parts by weight of the acrylic polymer.

3. Preparation of Adhesive Film

The adhesive composition was diluted with a solvent to adjust the viscosity at 25° C. to 500 to 1,500 cPs, and then mixed using a mechanical stirrer for 15 minutes or more, so that the mixture was well mixed. Then, after the mixture was allowed to stand at room temperature (25° C.), bubbles generated during mixing were generated, and a coating film was formed using an applicator. The coating film was dried at 140° C. for 3 minutes using a Mathis oven, thereby finally preparing an adhesive film having a thickness of 25 μm.

### EXPERIMENTAL EXAMPLES

1. Measurement of Storage Elastic Modulus

A storage elastic modulus was measured using Advanced Rheometric Expansion System G2 (TA Instruments). After the adhesive films of Examples and Comparative Examples were laminated several times to cut the adhesive film into a sample having a thickness of 1 mm, and the storage elastic modulus was measured using a parallel plate fixture having a diameter of 8 mm. The measurement conditions were 1 Hz, 5% strain, and a heating rate of 10° C./min.

2. Measurement of Haze

A haze was measured by a hazemeter (a COH-400 product manufactured by Nippon Denshoku Industries Co., Ltd.) after laminating the adhesive film to NEG glass 0.5T.

3. Measurement of Folding Characteristics

A folding structure was formed using the adhesive film (50 unn) of the Comparative Examples and the Examples, a cover window (manufactured by LGC, 13 unn hard coating on a 50 unn PET cross section), and CPI (Colorless Polymice, 50 unn). Specifically, a laminate was formed with a cover window/adhesive film/CPI structure, laminated, and then cut into a size of 140 mm×80 mm. Then, a total of 200,000 dynamic folding tests were performed at temperatures of −20° C., 25° C., and 60° C. using folding test equipment to repeat the folding test once per second with a radius of curvature of 4.5 mm, and then the sample was collected after completion of the test to observe bubble generation, lift-off, and cracks in the hard coating layer with the naked eye. The case where there were no bubbles or lift-off and there were no cracks in the hard coating layer was indicated as OK, and the case where there were bubbles and lift-off and cracks in the hard coating layer was indicated as NG.

4. Measurement of Adhesive Strength

An adhesive film was laminated on one surface of 50 unn PET and cut into a size of 1 inch. After corona treatment was performed on a surface opposite to the PET side of the adhesive film, the adhesive film was attached to the glass by reciprocating a 2-kg rubber roller once or more, allowed to stand at 23° C. for 1 day, and then peeled off at a peeling angle of 180° and a peeling speed of 300 mm to measure the adhesive strength using a texture analyzer (manufactured by Stable Micro Systems).

TABLE 2

| | | Example | Example | Example | Example | Example | Example |
|---|---|---|---|---|---|---|---|
| | | 1 | 2 | 3 | 4 | 5 | 6 |
| Type of | Polymer | ◯ | ◯ | ◯ | ◯ | ◯ | |
| acrylic | 1 | | | | | | |
| polymer | Polymer | | | | | | ◯ |
| | 2 | | | | | | |
| | Polymer | | | | | | |
| | 3 | | | | | | |
| | Polymer | | | | | | |
| | 4 | | | | | | |
| Ester- | Type | ATBC | TEG- | TBC | ATBC | ATBC | ATBC |
| based | | | EH | | | | |
| compound | Parts | 10 | 10 | 10 | 7 | 15 | 10 |
| | by | | | | | | |
| | weight | | | | | | |
| Cross- | BXX- | 0.1 | 0.1 | 0.1 | 0.1 | 0.1 | |
| linking | 5240 | | | | | | |
| agent | BXX- | 0.005 | 0.005 | 0.005 | 0.005 | 0.005 | |
| (unit: pt) | 5270 | | | | | | |
| | TKA- | | | | | | 0.07 |
| | 100 | | | | | | |
| Storage | −20° C. | 8.5 | 8.2 | 6.0 | 10 | 4.2 | 6.7 |
| elastic | (G1′) | | | | | | |
| modulus | 90° C. | 2.2 | 1.8 | 1.8 | 2.4 | 1.2 | 0.9 |
| (×10⁴, Pa) | (G2′) | | | | | | |
| | Log(G1/ | 0.584 | 0.664 | 0.531 | 0.620 | 0.561 | 0.897 |
| | G2) | | | | | | |
| Adhesive | (gf/in) | 850 | 700 | 750 | 900 | 700 | 1,100 |
| strength | | | | | | | |
| Haze | Unit: % | 0.5 | 0.7 | 0.8 | 0.7 | 0.4 | 0.5 |
| Folding | −20° C. | OK | OK | OK | OK/NG | OK | OK |
| charac- | 25° C. | OK | OK | OK | OK | OK | OK |
| teristics | 60° C. | OK | OK | OK | OK | OK | OK |
| | | | | Comparative | Comparative | Comparative | Comparative |
| | | Example | Example | Example | Example | Example | Example |
| | | 7 | 8 | 1 | 2 | 3 | 4 |
| Type of | Polymer | | | ◯ | ◯ | ◯ | ◯ |
| acrylic | 1 | | | | | | |
| polymer | Polymer | | | | | | |
| | 2 | | | | | | |
| | Polymer | ◯ | | | | | |
| | 3 | | | | | | |
| | Polymer | | ◯ | | | | |
| | 4 | | | | | | |
| Ester- | Type | ATBC | ATBC | X | PTT | DPGD | ATBC |
| based | Parts | 10 | 10 | X | 10 | 10 | 40 |
| compound | by | | | | | | |
| | weight | | | | | | |
| Cross- | BXX- | | 0.1 | 0.1 | 0.1 | 0.1 | 0.1 |
| linking | 5240 | | | | | | |
| agent | BXX- | | 0.005 | 0.005 | 0.005 | 0.005 | 0.005 |
| (unit: pt) | 5270 | | | | | | |
| | TKA- | 0.07 | | | | | |
| | 100 | | | | | | |
| Storage | −20° C. | 5.3 | 3.9 | 20.0 | 15.0 | 13.0 | 5.0 |
| elastic | (G1′) | | | | | | |
| modulus | 90° C. | 0.7 | 0.9 | 2.9 | 2.5 | 2.5 | 0.7 |
| (×10⁴, Pa) | (G2′) | | | | | | |
| | Log(G1/ | 0.906 | 0.662 | 0.839 | 0.778 | 0.716 | 0.852 |
| | G2) | | | | | | |
| Adhesive | (gf/in) | 1,200 | 1,100 | 1,800 | 1,200 | 950 | 90 |
| strength | | | | | | | |
| Haze | Unit: % | 0.5 | 0.6 | 1.2 | 5.8 | 2.7 | 0.2 |
| Folding | −20° C. | OK | OK | NG(Cracks) | NG(Cracks) | NG(Cracks) | OK |
| charac- | 25° C. | OK | OK | OK | OK | OK | NG(Desorp- |
| teristics | | | | | | | tion) |
| | 60° C. | OK | OK | OK | OK | OK | NG(Desorp- |
| | | | | | | | tion) |

TABLE 3
[ATBC: Weight average molecular weight (MW): 405]

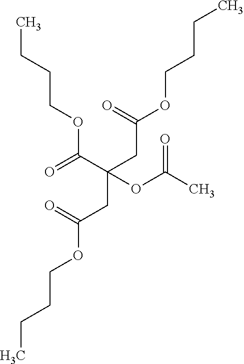 [SMILES: CCCCOC(=O)CC(CC(=O)OCCCC)(OC(C)=O)C(=O)OCCCC]

[TEG-EH
Weight average molecular weight (MW): 402]

[symbol]

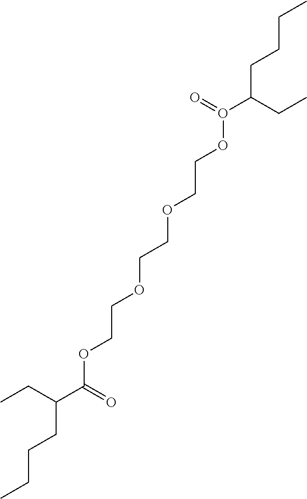

[TBC Weight average molecular weight (MW): 360]

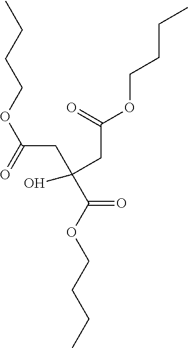 [SMILES: CCCCOC(=O)CC(O)(CC(=O)OCCCC)C(=O)OCCCC]

[PTT: Pentaerythritol Tetrakis,
Weight average molecular weight (MW): 545]

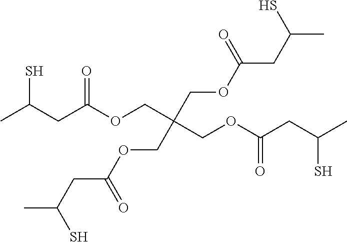 [SMILES: CC(S)CC(=O)OCC(COC(=O)CC(C)S)(COC(=O)CC(C)S)COC(=O)CC(C)S]

[DPGD: Di(propylene glycol)benzoate.
Weight average molecular weight (MW): 342]

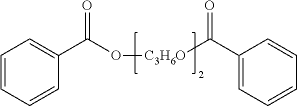

Since Examples 1 to 8 had a low storage elastic modulus at a low temperature and a high storage elastic modulus at a high temperature, it could be confirmed that the folding recovery characteristics were excellent. Further, since the haze values of Examples 1 to 8 are low, the optical characteristics are also excellent.

Since Comparative Example 1 did not include a citric acid ester-based compound, the low-temperature storage elastic modulus was high, so that it could be confirmed that the folding recovery characteristics were poor at low temperature.

In Comparative Example 2, since the ends of the citric acid ester-based compound included —SH instead of an alkyl group, the low-temperature modulus was high, so that it could be confirmed that the folding recovery characteristics were poor at low temperature. —SH is a highly reactive reaction group, and thus has high reactivity with the acrylic polymer, so that the free volume of the acrylic polymer is reduced. For this reason, the low-temperature folding recovery characteristics appear poorly.

In Comparative Example 3, since the ends of the citric acid ester-based compound included a benzene ring instead of an alkyl group, the low-temperature modulus was high, so that it could be confirmed that the folding recovery characteristics were poor at low temperature. The benzene ring is a substituent which is too large in size, and makes the structure of the citric acid ester-based compound complicated. As a result, the free volume of the acrylic polymer is reduced, and the low-temperature folding recovery characteristics are shown to be poor.

In the case of Comparative Example 4, the content of the citric acid ester-based compound is so high that the adhesive strength is lowered, and desorption occurs during high-temperature folding.

In contrast, the ends of the citric acid ester-based compounds of Examples 1 to 8 were substituted with hydrogen or an alkyl group, so that and the reactivity with the acrylic polymer was adjusted so as not to be too high, and the structure of the citric acid ester-based compound is not complicated, so that the free volume of the acrylic polymer is increased. Through this, the low-temperature folding recovery characteristics are shown to be excellent.

1. An adhesive composition comprising:
an acrylic polymer having a glass transition temperature of −40° C. or less; and
a citric acid ester-based compound having a hydrogen or an alkyl group at its end.

2. The adhesive composition of claim 1, wherein the citric acid ester-based compound has a weight average molecular weight of 1,000 g/mol or less.

3. The adhesive composition of claim 1, wherein the alkyl group is an alkyl group having 1 to 10 carbon atoms.

4. The adhesive composition of claim 1, wherein the citric acid ester-based compound is comprised in an amount of 5 parts by weight to 30 parts by weight based on 100 parts by weight of the entire acrylic polymer.

5. The adhesive composition of claim 1, wherein the acrylic polymer is composed of a polymerization unit of a (meth)acrylic acid ester monomer and a polymerizable monomer having a cross-linkable functional group.

6. The adhesive composition of claim 5, wherein the (meth)acrylic acid ester monomer is alkyl(meth)acrylate.

7. The adhesive composition of claim 5, wherein the cross-linkable functional group is any one or more selected from the group consisting of a hydroxyl group, an isocyanate group, a glycidyl group, an epoxy group, an amine group, and a carboxyl group.

8. The adhesive composition of claim 5, wherein the acrylic polymer is composed of a polymerization unit of 90 to 99.5 parts by weight of a (meth)acrylic acid ester monomer and 0.5 to 10 parts by weight of a polymerizable monomer having a cross-linkable functional group.

9. The adhesive composition of claim 1, further comprising a cross-linking agent for the acrylic polymer.

10. The adhesive composition of claim 9, wherein the cross-linking agent is comprised in an amount of 0.001 to 5 parts by weight based on 100 parts by weight of the acrylic polymer.

11. An adhesive film comprising a dried or cured product of the adhesive composition of claim 1,
wherein the adhesive film satisfies the following Equations 1 and 2:
1×10⁴≤G1′≤1×10⁶ [Equation 1]
1×10⁴≤G2′≤1×10⁵ [Equation 2]
in the Equations 1 and 2,
G1′ is a storage elastic modulus (Pa) at −20° C., and
G2′ is a storage elastic modulus (Pa) at 90° C.

12. The adhesive film of claim 11, wherein the adhesive film satisfies the following Equation 3:
Log(G1′/G2′)≤1 [Equation 3]
in the Equation 3,
G1′ is a storage elastic modulus (Pa) at −20° C., and
G2′ is a storage elastic modulus (Pa) at 90° C.

13. The adhesive film of claim 11, wherein the adhesive film has a haze of 3% or less at a thickness of 25 μm.

14. The adhesive film of claim 11, further comprising any one or more of a release film and a base film provided on one surface or both surfaces of a dried or cured product of the adhesive composition.

15. A foldable display device comprising the adhesive film of claim 11.

16. The adhesive composition of claim 1, wherein the citric acid ester-based compound is triethyl citrate, acetyl triethyl citrate, tributyl citrate, acetyl tributyl citrate (ATBC), or acetyl trioctyl citrate.
